(19) United States
(12) Patent Application Publication
(10) Pub. No.: US 2026/0288263 A1
(43) Pub. Date: Sep. 24, 2026

(54) ROTARY OPERATION MEMBER AND SOUND CONTROL DEVICE

(71) Applicant: AlphaTheta Corporation, Yokohama-shi, Kanagawa (JP)

(72) Inventors: Katsuhiro Shiba, Yokohama-shi, Kanagawa (JP); Nao Takagi, Yokohama-shi, Kanagawa (JP)

(21) Appl. No.: 19/476,319

(22) PCT Filed: Apr. 20, 2023
(86) PCT No.: PCT/JP2023/015755

§ 371 Date: Oct. 17, 2025

(51) Int. Cl. G06F 3/0362; G06F 3/16

(52) U.S. Cl. CPC G06F 3/0362; G06F 3/165

(57) ABSTRACT

A rotary operator includes: a shaft portion rotatable around a rotation axis; a first rotary body rotatable together with the shaft portion; a second rotary body having a second surface, the second surface being configured to come into surface contact with a first surface of the first rotary body; a rotary damper connected to the second rotary body; and a pressing portion configured to press the first rotary body against the second rotary body.

### TECHNICAL FIELD

The present invention relates to a rotary operator and an audio control device.

### BACKGROUND ART

An acoustic device provided with a rotary operator has been known (see, for example, Patent Literature 1).

The acoustic device described in Patent Literature 1 includes a housing for accommodating a signal processing circuit and an operating device provided on a front surface of the housing. The operating device is a rotary input device used for adjusting a volume of reproduced sound. The operating device includes a rotation shaft, an operating member in a form of an operating knob provided at one end portion of the rotation shaft, a changeable resistor provided at the other end portion of the rotation shaft, a first supporter, and a second supporter.

The first supporter and the second supporter are opposed to each other with a space therebetween. A first bearing is disposed in a first through hole of the first supporter, and a second bearing is disposed in a second through hole of the second supporter. The rotation shaft is supported by the first bearing and the second bearing.

### CITATION LIST

### Patent Literature(s)

Patent Literature 1: JP 2019-109589 A

### SUMMARY OF THE INVENTION

### Problem(s) to be Solved by the Invention

In the operating device described in Patent Literature 1, a rotation load on the rotation shaft increases according to a rotation speed of the rotation shaft. Therefore, when the rotation shaft is rotated at a low speed, the rotation load on the rotation shaft is relatively small, so that the rotation shaft is easily rotated. On the other hand, when the rotation shaft is rotated at a high speed, the rotation load on the rotation shaft is relatively larger, making it difficult to rotate the rotation shaft.

For this reason, there has been a demand for a rotary operator that is easy to operate for both the rotation at a low speed and the rotation at a high speed.

An object of the invention is to provide a rotary operator that is easy to operate for rotation and an audio control device.

### Means for Solving the Problem(s)

A rotary operator according to a first aspect of the invention includes: a shaft portion rotatable around a rotation axis; a first rotary body rotatable together with the shaft portion; a second rotary body having a second surface, the second surface configured to come into surface contact with a first surface of the first rotary body; a rotary damper connected to the second rotary body; and a pressing portion configured to press the first rotary body against the second rotary body.

An audio control device according to a second aspect of the invention includes the rotary operator according to the above first aspect.

### BRIEF DESCRIPTION OF DRAWINGS

FIG. 1 schematically illustrates a configuration of an audio control device according to a first exemplary embodiment.

FIG. 2 is a perspective view illustrating a rotary operator according to the first exemplary embodiment.

FIG. 3 is another perspective view illustrating the rotary operator according to the first exemplary embodiment.

FIG. 4 is a cross-sectional view of the rotary operator according to the first exemplary embodiment.

FIG. 5 is another cross-sectional view of the rotary operator according to the first exemplary embodiment.

FIG. 6 is a perspective view illustrating a housing according to the first exemplary embodiment.

FIG. 7 is a perspective view illustrating an operator body according to the first exemplary embodiment.

FIG. 8 is an exploded perspective view illustrating the operator body according to the first exemplary embodiment.

FIG. 9 is another exploded perspective view illustrating the operator body according to the first exemplary embodiment.

FIG. 10 is an exploded perspective view illustrating a pressing portion according to the first exemplary embodiment.

FIG. 11 is another exploded perspective view illustrating the pressing portion according to the first exemplary embodiment.

FIG. 12 is a graph illustrating a rotation speed of a shaft portion and a rotation load on the shaft portion according to the first exemplary embodiment.

FIG. 13 is a perspective view illustrating an adjustment mechanism according to the first exemplary embodiment.

FIG. 14 is another graph showing the rotation speed of the shaft portion and the rotation load on the shaft portion according to the first exemplary embodiment.

FIG. 15 schematically illustrates a configuration of a cross fader according to a second exemplary embodiment.

### DESCRIPTION OF EMBODIMENT(S)

### First Exemplary Embodiment

A first exemplary embodiment of the invention will be described below with reference to the attached drawings.

### Configuration of Audio Control Device

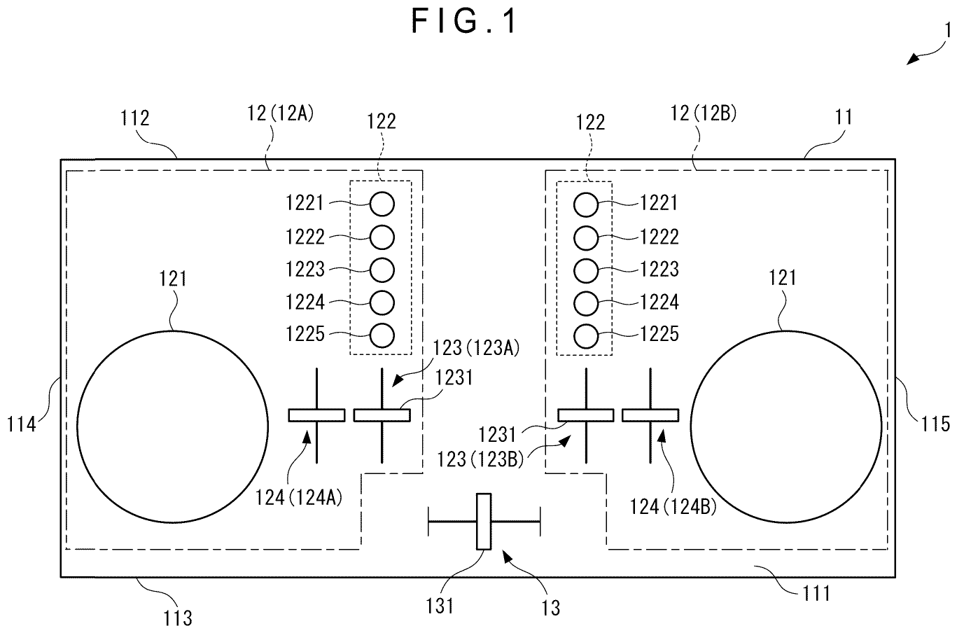

FIG. 1 schematically illustrates a configuration of an audio control device 1 according to the exemplary embodiment.

The audio control device 1 according to the exemplary embodiment mixes multiple music pieces. Specifically, the audio control device 1 mixes a first music piece loaded into a first channel and a second music piece loaded into a second channel, and outputs an audio signal corresponding to the mixed music piece.

As will be described in detail later, the audio control device 1 includes, as one of features thereof, the following modes: a normal mode for mixing the first and second music pieces in response to an operation on the operator and an assist mode for assisting the mixing of the first and second music pieces.

The audio control device 1 includes a housing 11, two channel operation sections 12, and a cross fader 13, as illustrated in FIG. 1. Although omitted in FIG. 1, the audio control device 1 further includes a controller that controls operations of the audio control device 1.

### Configuration of Housing

The housing 11 has a substantially rectangular parallelepiped shape and accommodates the controller therein. The housing 11 has a top surface 111, an upper surface 112, a lower surface 113, a left side surface 114, a right side surface 115, and a bottom surface (not illustrated).

The two channel operation sections 12 and the cross fader 13 are disposed on the top surface 111.

### Configuration of Channel Operation Sections

The two channel operation sections 12 operate playback states of music pieces loaded into the corresponding channels. The two channel operation sections 12 are a first channel operation section 12A that operates the playback state of the first music piece loaded into the first channel, and a second channel operation section 12B that operates the playback state of the second music piece loaded into the second channel.

The channel operation sections 12A and 12B each include a jog dial 121, an equalizer adjuster 122, a channel fader 123, and a tempo slider 124.

The jog dial 121 is rotatably provided on the top surface 111 and is used to adjust a playback direction and a playback speed of the music piece being played. A user performs a scratch operation unique to DJ performances by combining changes in a rotation direction and a rotation speed of the jog dial 121.

The equalizer adjuster 122 performs equalizer adjustment for the corresponding channel. Specifically, the equalizer adjuster 122 of the first channel operation section 12A performs equalizer adjustment for the first channel, and the equalizer adjuster 122 of the second channel operation section 12B performs equalizer adjustment for the second channel. The equalizer adjusters 122 each include a level adjuster 1221, a high-frequency band adjuster 1222, a mid-frequency band adjuster 1223, a low-frequency band adjuster 1224, and an effect adjuster 1225.

At least one of the level adjuster 1221, high-frequency band adjuster 1222, mid-frequency band adjuster 1223, low-frequency band adjuster 1224, or effect adjuster 1225 is configured by a rotary operator 2 to be described later.

The level adjuster 1221 adjusts an input level of an input music piece.

The high-frequency band adjuster 1222 adjusts a volume level in the high-frequency band of the input music piece. The high-frequency band is, for example, a frequency band of 4,649 Hz or higher.

The mid-frequency band adjuster 1223 adjusts a volume level in the mid-frequency band of the input music piece. The mid-frequency band is, for example, a frequency band higher than 284 Hz and lower than 4,649 Hz.

The low-frequency band adjuster 1224 adjusts the maximum volume level in the low-frequency band of the input music piece. The low-frequency band is, for example, a frequency band of 284 Hz or lower.

The effect adjuster 1225 is an operator that adjusts an effect amount of an effect set in the corresponding channel operation section 12.

The channel fader 123 is an operator that adjusts a volume output from the corresponding channel operation section 12 and, consequently, a volume output from the audio control device 1. Specifically, the channel fader 123 of the first channel operation section 12A is a first channel fader 123A, which adjusts the volume output from the audio control device 1. The channel fader 123 of the second channel operation section 12B is a second channel fader 123B, which adjusts the volume output from the audio control device 1.

The channel faders 123 each include a fader operator 1231 that is vertically slidable. When the fader operator 1231 is operated upward, the volume of the entire music output from the corresponding channel operation section 12 is increased. When the fader operator 1231 is operated downward, the volume of the entire music output from the corresponding channel operation section 12 is decreased.

The channel fader 123 is not limited to a configuration including the slidable fader operator 1231, and another configuration including the rotary operator 2 to be described later may be adopted.

The tempo slider 124 adjusts Beats Per Minute (BPM) during playback of a music piece loaded into the corresponding channel to adjust the playback speed of the music piece. BPM of a music piece refers to a tempo of the music piece, i.e., the number of beats per minute of the music piece.

The tempo slider 124 of the first channel operation section 12A is a first tempo slider 124A, which adjusts BPM during playback of the first music piece loaded into the first channel. The tempo slider 124 of the second channel operation section 12B is a second tempo slider 124B, which adjusts BPM during playback of the second music piece loaded into the second channel.

The tempo slider 124 is not limited to a configuration including a slidable operator, and another configuration including the rotary operator 2 to be described later may be adopted.

### Configuration of Cross Fader

The cross fader 13 includes a fader operator 131 that is movable right and left, and adjusts the balance between the volume of the first music piece loaded into the first channel and the volume of the second music piece loaded into the second channel. As the fader operator 131 is moved toward the first channel operation section 12A, a volume proportion of the first music piece increases in the volume output from the audio control device 1. As the fader operator 131 is moved toward the second channel operation section 12B, a volume proportion of the second music piece increases in the volume output from the audio control device 1.

### Configuration of Rotary Operator

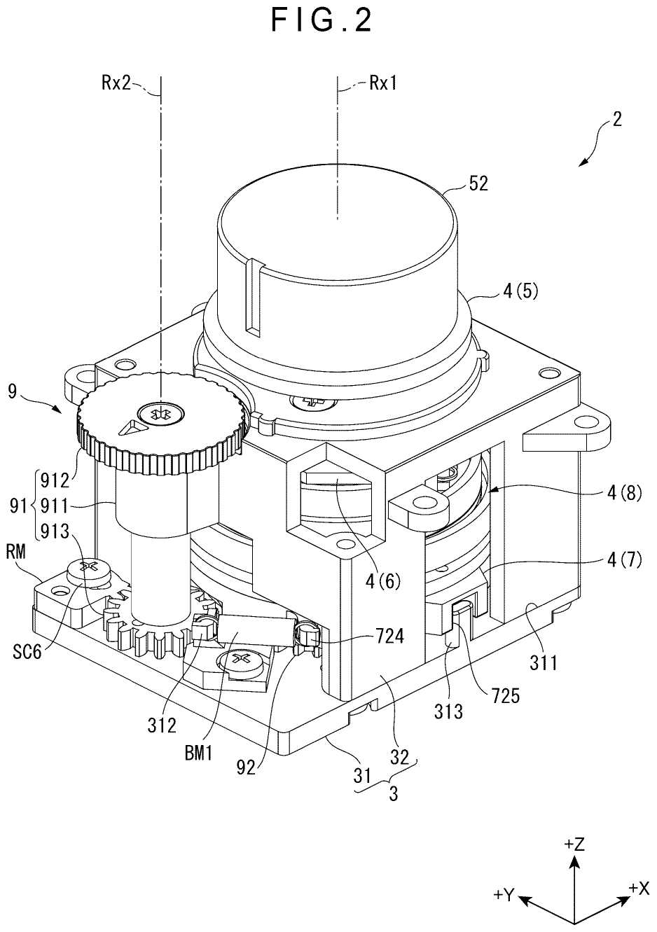

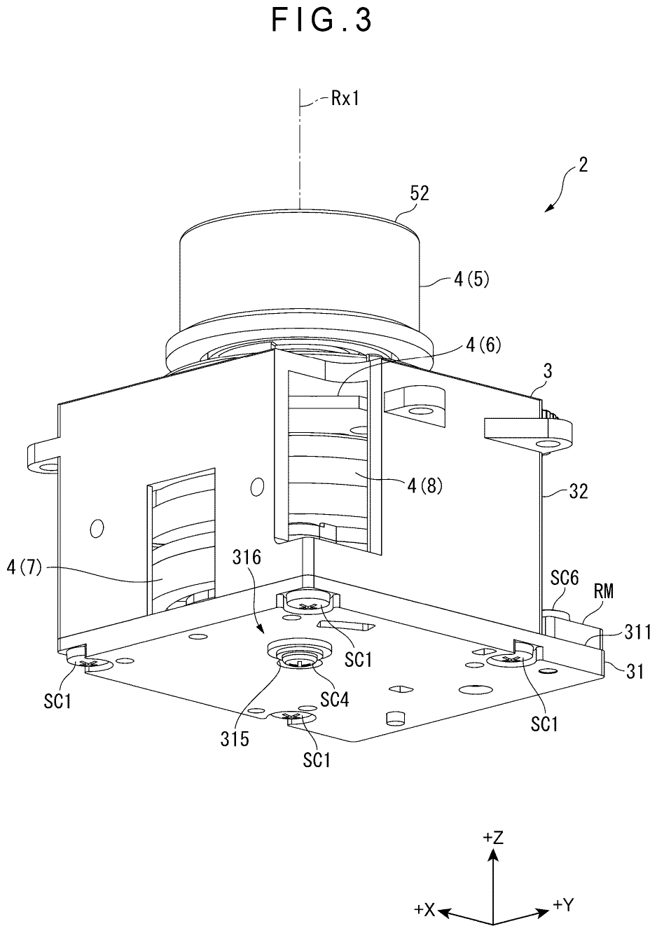

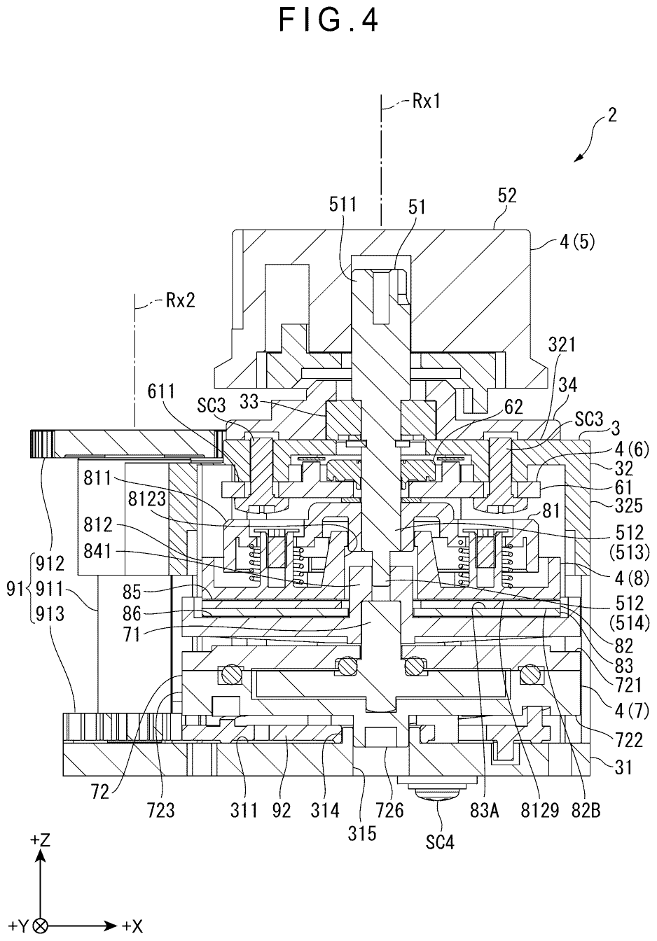

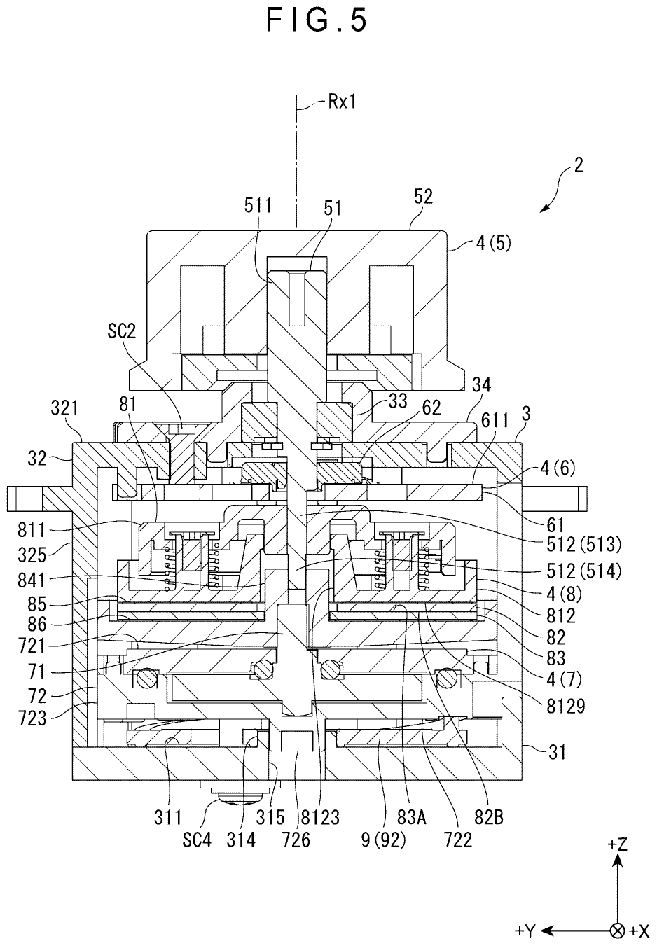

FIGS. 2 and 3 are perspective views illustrating the rotary operator 2. More specifically, FIG. 2 is a perspective view of the rotary operator 2 viewed from above, and FIG. 3 is a perspective view of the rotary operator 2 viewed from below. FIG. 4 is a cross-sectional view of the rotary operator 2 along an XZ plane to be described later, and FIG. 5 is a cross-sectional view of the rotary operator 2 along a YZ plane to be described later.

The rotary operator 2 constitutes at least one of the adjusters 1221 to 1225, as described above. The rotary operator 2, which is operated and rotated by a user, is configured to reduce a rotation load when rotated at a high speed. The rotation load can also be expressed as a load torque.

The rotary operator 2 includes a housing 3, an operator body 4, and an adjustment mechanism 9, as illustrated in FIGS. 2 to 5.

Hereinafter, mutually orthogonal three directions are defined as a +X direction, a +Y direction, and a +Z direction. The +Z direction, which is along a rotation axis Rx1 of a shaft portion 5 included in the operator body 4, is a direction rising from an arrangement surface 311 of a base 31 that constitutes the housing 3 and being away from the base 31.

Directions opposite to the +X direction, the +Y direction, and the +Z direction are defined as a −X direction, a −Y direction, and a −Z direction, respectively, though the illustration thereof is omitted. Further, axes along the +X direction, the +Y direction and the +Z direction are defined as an X axis, a Y axis, and a Z axis, respectively.

### Configuration of Housing

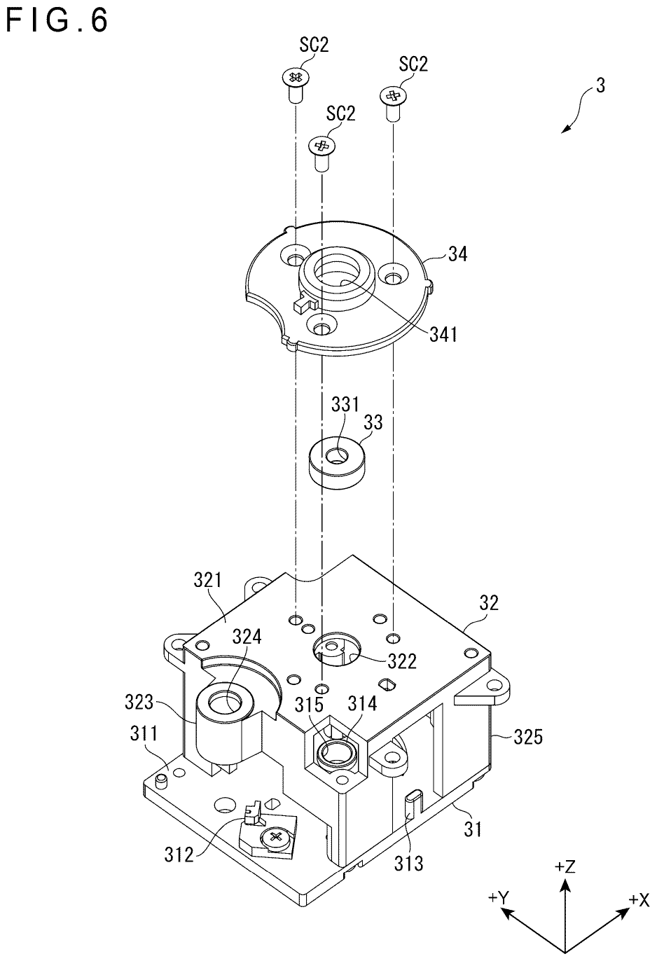

FIG. 6 is a perspective view illustrating the housing 3 viewed from above.

The housing 3 is a housing in which the operator body 4 and the adjustment mechanism 9 are disposed. The housing 3 includes the base 31, a holding member 32, a bearing 33, and a cover member 34, as illustrated in FIG. 6.

### Configuration of Base

The base 31 is a flat plate body, as illustrated in FIG. 3. The base 31 includes the arrangement surface 311 on which the holding member 32, the operator body 4, and the adjustment mechanism 9 are disposed, as illustrated in FIGS. 2 to 6. The base 31 also includes a locking portion 312, a restricting portion 313, a boss 314, and a hole 315 provided on the arrangement surface 311, as illustrated in FIG. 6.

The arrangement surface 311 faces the +Z direction in the housing 3.

The locking portion 312 locks one end of a biasing member BM1 (see FIG. 2) that biases a rotary damper 7 to be described later of the operator body 4.

The restricting portion 313 is a projection protruding in the +Z direction from a −Y-directional end of the arrangement surface 311. The restricting portion 313 restricts the rotary damper 7 from rotating around a rotation axis along the Z axis, by being inserted into the rotary damper 7 from the −Z direction.

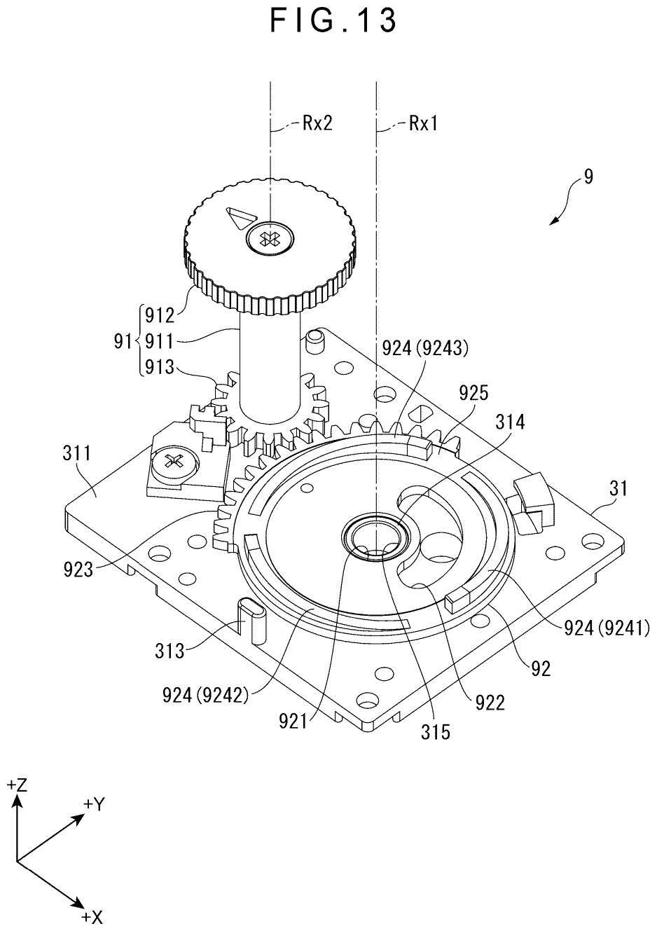

The boss 314 is provided on the arrangement surface 311 at approximately the center of a region covered by the holding member 32 in the +Z direction, and has a hollow cylindrical shape protruding in the +Z direction from the arrangement surface 311. The boss 314 is inserted into an insertion opening 921 (see FIG. 13) of a cam member 92 to be described later.

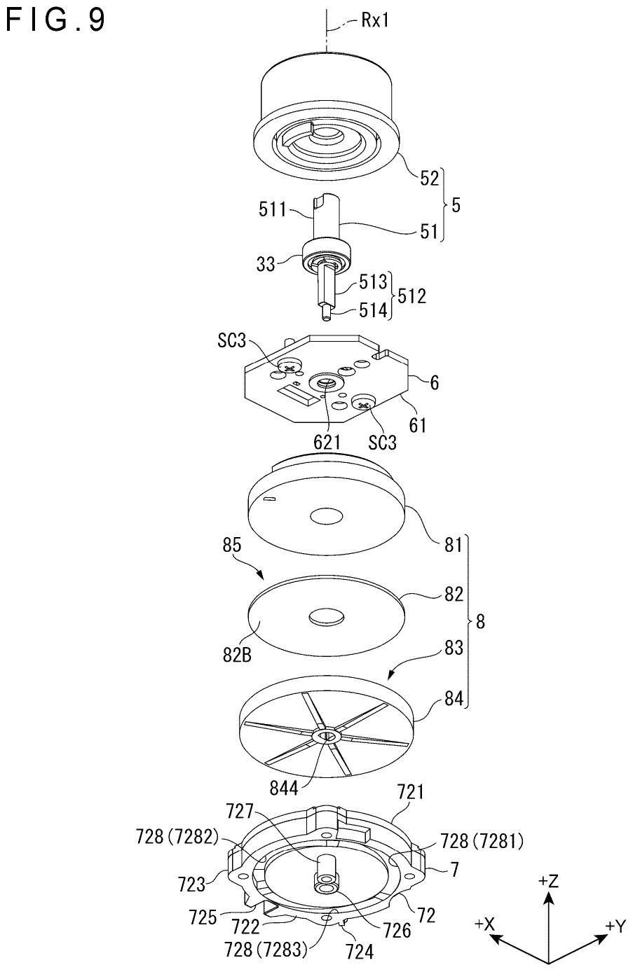

The hole 315 passes through the boss 314 along the Z axis. A fitting portion 726 (see FIG. 9) of the rotary damper 7 to be described later of the operator body 4 is inserted into the hole 315.

Further, the base 31 has a hole 316 provided adjacent to the hole 315, as illustrated in FIG. 3. A boss 727 of the rotary damper 7 to be described later is inserted into the hole 316.

### Configuration of Holding Member

The holding member 32 is disposed in the +Z direction relative to the base 31 and fixed to the base 31. The holding member 32 has a box shape that is open on a base 31 side. The holding member 32 combined with the base 31 accommodates a part of the operator body 4 and the adjustment mechanism 9 between the holding member 32 and the base 31.

As illustrated in FIG. 6, the holding member 32 includes a top surface portion 321 having a substantially rectangular shape and a side surface portion 325 extending from a peripheral edge of the top surface portion 321 toward the base 31.

The top surface portion 321 of the holding member 32 faces the +Z direction.

An end of the side surface portion 325 is fixed to the base 31 by screws SC1, as illustrated in FIG. 3. The side surface portion 325 covers a part of the operator body 4 in the +X direction and the ±Y direction.

The holding member 32 has an insertion opening 322 and a support portion 323 that are provided in the top surface portion 321.

The insertion opening 322 is a circular through-hole that passes through the top surface portion 321 along the Z axis. The shaft portion 5 to be described later of the operator body 4 is inserted through the insertion opening 322.

The support portion 323 is a hollow cylindrical portion protruding in the −X direction from the side surface portion 325 in the −X direction. More specifically, the support portion 323 is a hollow cylindrical portion provided so that a central axis thereof is along the Z axis. The support portion 323 has a hole 324 through which a shaft 911 of the adjustment mechanism 9 is inserted along the Z axis.

### Configuration of Bearing and Cover Member

The bearing 33 is provided on the top surface portion 321 corresponding to the insertion opening 322. The shaft portion 5 of the operator body 4 is inserted through an opening 331 provided in the bearing 33. The bearing 33 is fixed to the shaft portion 5 by a washer (not illustrated).

The cover member 34 is fixed to the top surface portion 321 by screws SC2 so as to cover a part of the top surface portion 321 and the bearing 33 in the +Z direction. The cover member 34 is connected to an outer circumferential surface of the bearing 33. With this configuration, the shaft portion 5 is rotatably supported by the housing 3. The cover member 34 has an opening 341 that passes through the cover member 34 along the Z axis. A shaft 51 of the shaft portion 5 is inserted through the openings 331 and 341 along the −Z direction.

### Configuration of Operator Body

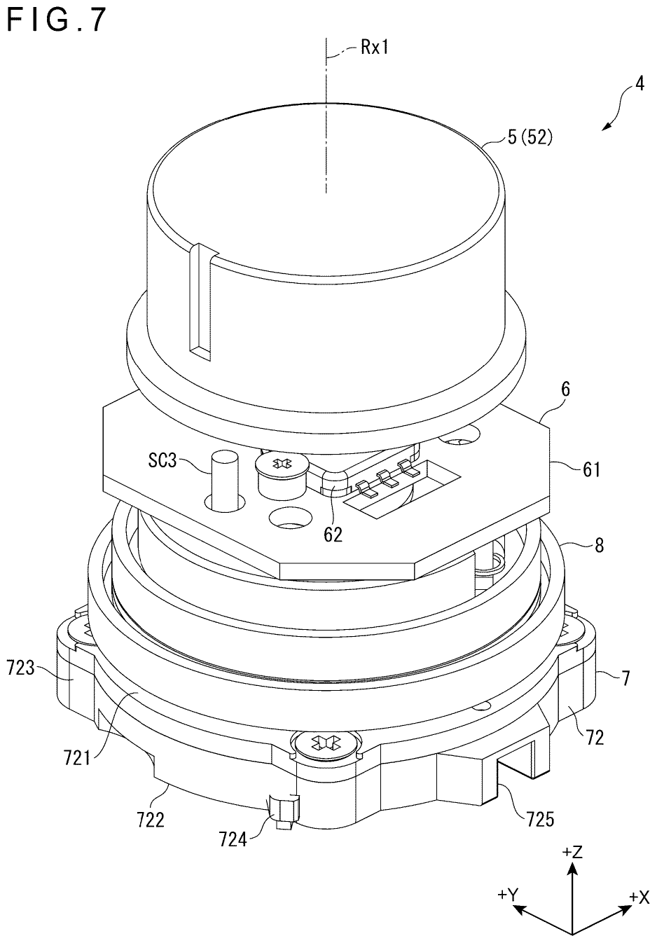

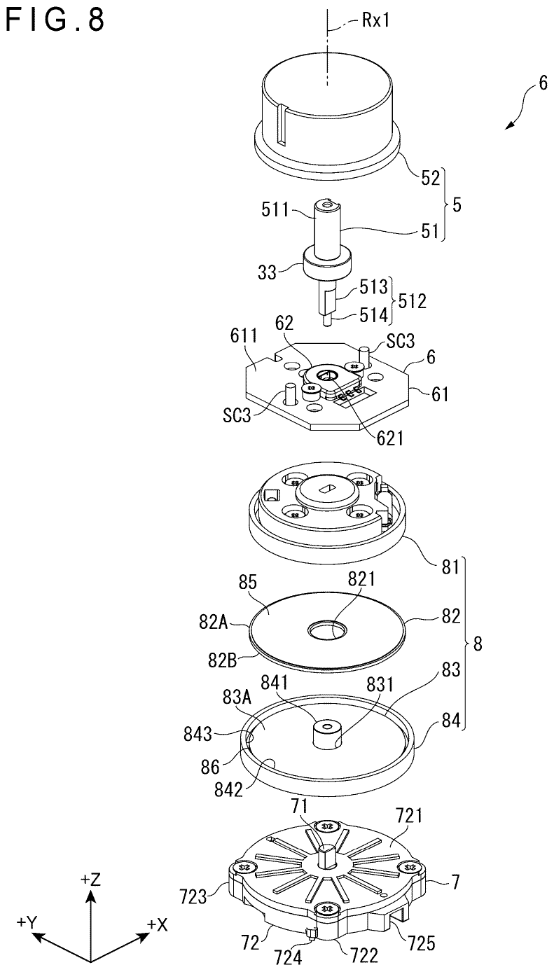

FIG. 7 is a perspective view illustrating the operator body 4 viewed from the +Z direction. FIG. 8 is an exploded perspective view illustrating the operator body 4 viewed from the +Z direction, and FIG. 9 is an exploded perspective view illustrating the operator body 4 viewed from the −Z direction.

The operator body 4 is an operator that detects a rotation operation by a user. More specifically, the operator body 4 detects a rotation angle of the shaft portion 5 rotated by the user. The operator body 4 includes the shaft portion 5, a detector 6, the rotary damper 7, and a rotation transmitting mechanism 8, as illustrated in FIGS. 7 to 9.

### Configuration of Shaft Portion

The shaft portion 5 is provided in the housing 3 to be rotatable around the rotation axis along the Z axis by the bearing 33 described above, and receives the rotation operation by a user. The shaft portion 5 includes an operation knob 52 illustrated in FIGS. 7 to 9 in addition to the shaft 51 illustrated in FIGS. 8 and 9.

The shaft 51 is a rod member having a substantially columnar shape disposed along the Z axis, as illustrated in FIGS. 8 and 9. The shaft 51 is inserted into the bearing 33 described above. The bearing 33 is positioned approximately at the center of the shaft 51 on the Z axis.

The operation knob 52 is fixed to a +Z-directional end 511 of the shaft 51.

A −Z-directional end 512 of the shaft 51 has an insertion portion 513 and a protrusion 514.

The insertion portion 513 has a substantially quadrangular prism shape. The insertion portion 513 is inserted into a pressing portion 81 of the rotation transmitting mechanism 8 after being inserted through a detector body 62 to be described later of the detector 6.

The protrusion 514 protrudes in a columnar shape in the −Z direction from a −Z-directional end of the insertion portion 513. The protrusion 514 is inserted into a holding member 84 to be described later of the rotation transmitting mechanism 8.

The operation knob 52 has an outer diameter larger than that of the shaft 51 centered on the rotation axis Rx1. The operation knob 52 is a portion that is gripped by the user in the operator body 4, and when the operation knob 52 is rotated around the rotation axis Rx1, the shaft 51 and thus the shaft portion 5 are rotated around the rotation axis Rx1.

### Configuration of Detector

The detector 6 detects the rotation operation of the shaft portion 5. Specifically, the detector 6 detects the rotation angle of the rotated shaft portion 5. The detector 6 includes a fixed member 61 and the detector body 62.

The fixed member 61 is a plate member having a flat plate shape and is fixed by screws SC3 to a surface facing the −Z direction of the top surface portion 321 of the housing 3 described above.

The detector body 62 is disposed on an arrangement surface 611 facing the +Z direction of the fixed member 61. The detector body 62 has a through hole 621 through which the shaft 51 of the shaft portion 5 is inserted along the Z axis. In the exemplary embodiment, the detector body 62 is a variable resistor (potentiometer) whose output voltage changes according to the rotation operation on the shaft portion 5 by a user, and the controller (not illustrated) of the audio control device 1 acquires the rotation angle of the shaft portion 5 based on the output voltage from the detector body 62. However, the detector body 62 is not limited thereto and may also be a rotary encoder that includes a rotating portion that rotates together with the shaft portion 5 and a sensor that detects the rotation angle of the rotating portion.

### Configuration of Rotary Damper

The rotary damper 7 is a viscous resistance type rotary damper that provides a resistance to the rotation of the shaft portion 5 by applying a braking force generated by oil viscosity resistance to the rotation of the shaft portion 5 transmitted through the rotation transmitting mechanism 8. The rotary damper 7 includes a rotary member 71 and a container 72, as illustrated in FIGS. 8 and 9.

The rotary member 71 is disposed in the container 72 so that a part of the rotary member 71 protrudes in the +Z direction from the container 72. The rotary member 71 is inserted into the holding member 84 to be described later of the rotation transmitting mechanism 8, and is rotated together with the holding member 84 around the rotation axis Rx1.

The container 72 supports the rotary member 71 to be rotatable around the rotation axis Rx1. Viscous oil such as silicone oil, which is sealed in the container 72, serves as resistance when the rotary member 71 rotates, though the illustration of the viscous oil is omitted.

In the above-described rotary damper 7, a rotary torque changes according to a rotation speed of the rotary member 71. For example, when the rotation speed of the rotary member 71 is high, the rotary torque of the rotary member 71 is large, and when the rotation speed of the rotary member 71 is low, the rotary torque of the rotary member 71 is small. As a result, a rotary torque of the shaft portion 5 connected to the rotary member 71 via the rotation transmitting mechanism 8 changes.

The container 72 has a surface 721 facing the +Z direction, a surface 722 facing the −Z direction, and a side surface 723 connecting the surfaces 721 and 722. In addition, the container 72 includes a locking portion 724 and a recess 725 as illustrated in FIGS. 7 and 8.

The locking portion 724 is provided on a side surface facing the −X direction of the side surface 723. The locking portion 724 has a hook shape and locks the other end of the biasing member BM1, one end of which is locked by the locking portion 312 of the base 31.

The recess 725 is provided on the side surface facing the −Y direction of the side surface 723 and is open in the −Z direction and the −Y direction. As described above, the base 31 of the housing 3 has the restricting portion 313 (see FIG. 2) that is inserted into the recess 725, thereby restricting rotation of the container 72 around the rotation axis Rx1 and, consequently, rotation of the rotary damper 7.

The container 72 further includes the fitting portion 726, the boss 727, and a groove 728, as illustrated in FIG. 9.

The fitting portion 726 is a hollow cylindrical portion protruding in the −Z direction that is positioned at the center of the container 72 as viewed from the −Z direction. The fitting portion 726 is inserted through the cam member 92 along the Z axis to be inserted into the hole 315 (see FIGS. 4 and 5) of the base 31. The cam member 92, which is one of components of the adjustment mechanism 9 to be described later, is disposed in the −Z direction relative to the rotary damper 7.

The boss 727 is disposed on an outer circumferential side of the container 72 with respect to the fitting portion 726 as viewed from the −Z direction and protrudes in the −Z direction. The boss 727 is inserted through the cam member 92 along the Z axis to be inserted into the hole 316 of the base 31. Further, the boss 727 can be fixed to the base 31 by a screw SC4 after load adjustment is performed by the adjustment mechanism 9 to be described later. Since the rotary damper 7 is fixed to the base 31 by the above fixing, it is possible to remove the biasing member BM1.

The groove 728 is provided in the surface 722 facing the −Z direction. The groove 728 is a spiral groove centered on the rotation axis Rx1 and recessed in the +Z direction from the surface 722. More specifically, the groove 728 is divided into three regions 7281, 7282, and 7283 at equal intervals along a circumferential direction centered on the rotation axis of the rotary member 71. In each of the regions 7281 to 7283, a recessed amount in the +Z direction from the surface 721 increases in a counterclockwise direction as viewed from the −Z direction.

An end face cam portion 924 of the cam member 92 is inserted into the groove 728. As will be described in more detail below, when the cam member 92 rotates around the rotation axis Rx1, the rotary damper 7, whose rotation is restricted by the restricting portion 313, is moved in the +Z direction or the −Z direction.

### Configuration of Rotation Transmitting Mechanism

The rotation transmitting mechanism 8 is disposed between the detector 6 and the rotary damper 7 on the Z axis, as illustrated in FIGS. 4 to 8. The rotation transmitting mechanism 8 connects the shaft 51 of the shaft portion 5 to the rotary damper 7, and transmits the rotation of the shaft portion 5 to the rotary damper 7. Further, the rotation transmitting mechanism 8 switches a transmission state of the rotation from the shaft portion 5 to the rotary damper 7 to change a rotation load on the shaft 51. Specifically, the rotation transmitting mechanism 8 switches the transmission state between a state in which the rotation of the shaft portion 5 is transmitted to the rotary damper 7 and the rotation load by the rotary damper 7 acts on the shaft portion 5, and a state in which the rotation of the shaft portion 5 is not transmitted to the rotary damper 7 and the rotation load by the rotary damper 7 does not act on the shaft portion 5.

The rotation transmitting mechanism 8 includes the pressing portion 81, a first rotary body 82, a second rotary body 83, and the holding member 84.

### Schematic Configuration of Pressing Portion

The pressing portion 81 presses one of the first rotary body 82 and the second rotary body 83 toward the other of the rotary bodies. In the exemplary embodiment, the pressing portion 81, which is disposed between the first rotary body 82 and the detector 6 on the Z axis, presses the first rotary body 82 toward the second rotary body 83. A configuration of the pressing portion 81 will be described in detail later.

### Configuration of First Rotary Body

The first rotary body 82, which is disposed orthogonal to the rotation axis Rx1, rotates together with the pressing portion 81 connected to the shaft 51 of the shaft portion 5. That is, the first rotary body 82 rotates together with the shaft portion 5 around the rotation axis Rx1. In the exemplary embodiment, the first rotary body 82 is a disc-shaped member and has a circular opening 821 at the center thereof as viewed from the +Z direction, and an insertion portion 841 of the holding member 84 is inserted through the circular opening 821 from the −Z direction.

The first rotary body 82 is provided with an adhesive tape 85 on a surface 82A in the +Z direction opposing the pressing portion 81. The first rotary body 82 is adhered to the pressing portion 81 through the adhesive tape 85, so that the first rotary body 82 is rotated together with the pressing portion 81. That is, the first rotary body 82 is provided integrally with the pressing portion 81. The surface 82A of the first rotary body 82 and a surface in the −Z direction of the pressing portion 81 may be fixed to each other by adhesive or the like. In this case, the adhesive tape 85 can be omitted.

The first rotary body 82 has a surface 82B in the −Z direction opposing the second rotary body 83. The surface 82B corresponds to a first surface and is frictionally engaged with a surface 83A in the +Z direction of the second rotary body 83. The surface 82B is orthogonal to the rotation axis Rx1.

### Configuration of Second Rotary Body

The second rotary body 83 is disposed orthogonal to the rotation axis Rx1 and opposing the first rotary body 82. In the exemplary embodiment, the second rotary body 83 is a disc-shaped member and, as illustrated in FIG. 8, has a circular opening 831 at the center of the second rotary body 83 as viewed from the +Z direction, and the insertion portion 841 of the holding member 84 is inserted through the circular opening 831 from the −Z direction.

The second rotary body 83 is frictionally engaged with the first rotary body 82 at the surface 83A in the +Z direction opposing the first rotary body 82. The surface 83A corresponds to a second surface and is orthogonal to the rotation axis Rx1.

Therefore, when the first rotary body 82 rotates at a low speed, the second rotary body 83 rotates integrally with the first rotary body 82 around the rotation axis Rx1.

On the other hand, when the first rotary body 82 rotates at a high speed and the load torque of the rotary damper 7 increases and exceeds a friction torque, the first rotary body 82 slips relative to the second rotary body 83. In this case, the second rotary body 83 does not follow the rotation of the first rotary body 82 and does not rotate integrally with the first rotary body 82.

### Configuration of Holding Member

The holding member 84 has a discoidal shape as viewed from the +Z direction. The holding member 84 accommodates and holds the first rotary body 82 and the second rotary body 83, and rotates integrally with the second rotary body 83 around the rotation axis Rx1. That is, the first rotary body 82 and the second rotary body 83 are disposed between the pressing portion 81 and the holding member 84 on the Z axis.

In the exemplary embodiment, the holding member 84 has an outer diameter centered on the rotation axis Rx1 larger than that of the pressing portion 81. However, the outer diameter of the holding member 84 is not limited thereto and may be the same in size as or smaller than the outer diameter of the pressing portion 81.

The holding member 84 includes the insertion portion 841 and a recess 842, as illustrated in FIG. 8.

The insertion portion 841 is a hollow cylindrical portion protruding in the +Z direction from the center of the holding member 84 as viewed from the +Z direction. The insertion portion 841 is inserted through the opening 831 of the second rotary body 83 and the opening 821 of the first rotary body 82 from the −Z direction, and is inserted into an insertion opening 8123 to be described later of the pressing portion 81. However, as illustrated in FIGS. 4 and 5, there is a gap between an outer circumferential surface of the insertion portion 841 and an inner edge of the opening 821 of the first rotary body 82, and between the outer circumferential surface of the insertion portion 841 and an inner surface of the insertion opening 8123. Therefore, the pressing portion 81 does not come into contact with the holding member 84.

As illustrated in FIG. 8, the recess 842 is provided on an outer side of the insertion portion 841 as viewed from the +Z direction and is recessed in the −Z direction. The first rotary body 82 and the second rotary body 83 are disposed in the recess 842. An adhesive tape 86 similar to the adhesive tape 85 is provided at a bottom 843 of the recess 842, and the second rotary body 83 is adhered to the bottom 843 through the adhesive tape 86. By this adhesion, the second rotary body 83 and the holding member 84 are integrated, and the holding member 84 rotates integrally with the second rotary body 83.

The surface in the −Z direction of the second rotary body 83 and the bottom 843 may be fixed to each other by adhesive or the like. In this case, the adhesive tape 86 can be omitted.

As illustrated in FIG. 9, the holding member 84 has a recess 844 provided at the center of the holding member 84 as viewed from the −Z direction. The recess 844 has a semicircular shape as viewed from the −Z direction, and the rotary member 71 of the rotary damper 7 is fitted into the recess 844 from the −Z direction. By this fitting, the rotary member 71 rotates integrally with the holding member 84 around the rotation axis Rx1.

### Configuration of Pressing Portion

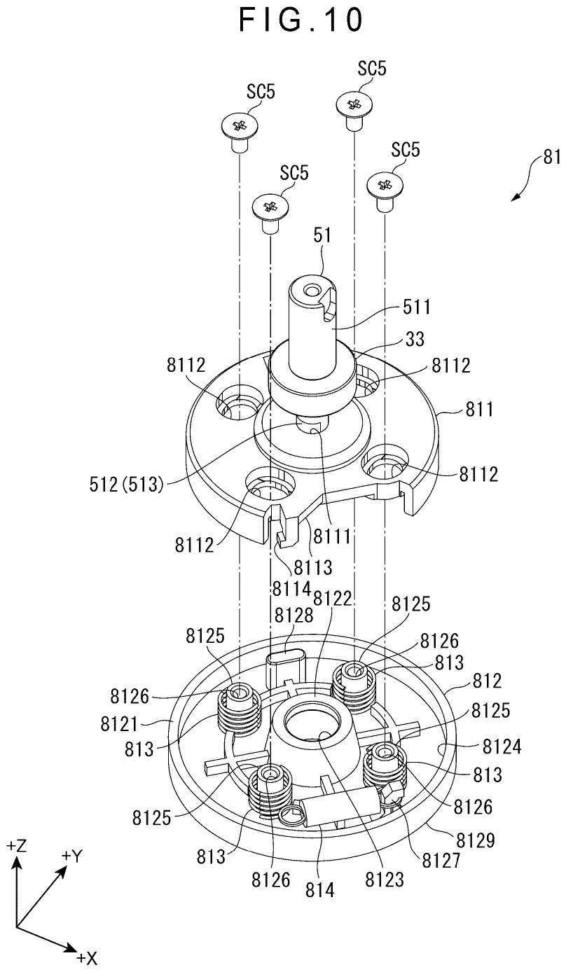

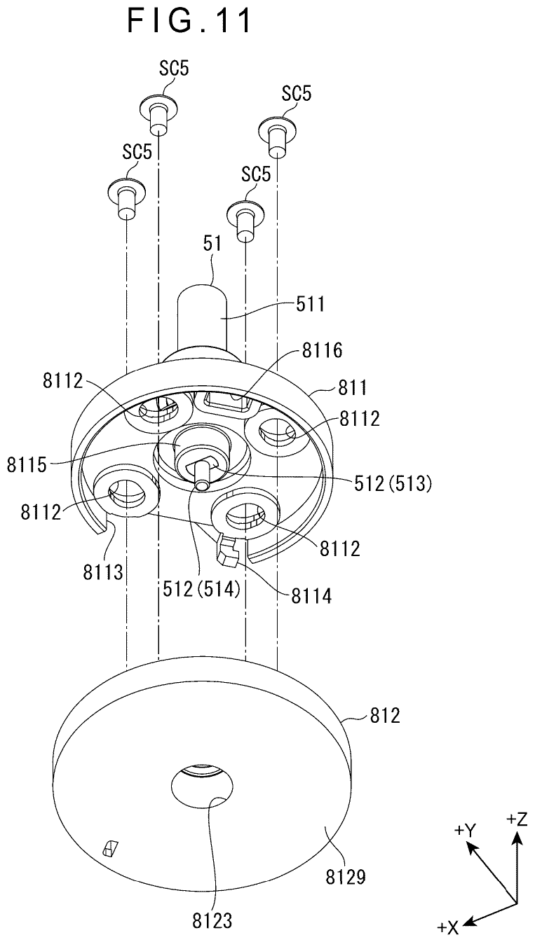

FIG. 10 is an exploded perspective view illustrating the pressing portion 81 viewed from the +Z direction, and FIG. 11 is an exploded perspective view illustrating the pressing portion 81 viewed from the −Z direction.

The pressing portion 81 presses the first rotary body 82 toward the second rotary body 83 as described above. The pressing portion 81, as illustrated in FIGS. 10 and 11, includes a first casing 811, a second casing 812, first biasing members 813, and a second biasing member 814.

The first casing 811 and the second casing 812 are fixed by multiple screws SC5 that are inserted through the first casing 811 along the Z axis and are fixed to the second casing 812.

### Configuration of First Casing

The first casing 811 has a substantially circular shape as viewed from the +Z direction and is disposed in the +Z direction relative to the second casing 812. The first casing 811, as illustrated in FIG. 10, includes an insertion opening 8111, two-stage holes 8112, a cutout 8113, and a locking portion 8114.

The insertion opening 8111 is provided at the center of the first casing 811 as viewed from the +Z direction and passes through the first casing 811 along the Z axis. The insertion portion 513 is inserted into the insertion opening 8111.

The multiple two-stage holes 8112 are provided at substantially equal intervals along a circumferential direction centered on the rotation axis Rx1. Each two-stage hole 8112 passes through the first casing 811 along the Z axis, and the screw SC5 for fixing the first casing 811 and the second casing 812 is inserted into the two-stage hole 8112.

The cutout 8113 is provided at a portion in the +X direction and in the −Y direction of the first casing 811 as viewed from the +Z direction. The cutout 8113 is provided for avoiding the second biasing member 814 disposed in the second casing 812 when the first casing 811 and the second casing 812 are assembled together.

The locking portion 8114 is provided at a position clockwise with respect to the cutout 8113 when the first casing 811 is viewed from the +Z direction. The locking portion 8114 has a hook shape and locks one end of the second biasing member 814.

As illustrated in FIG. 11, the first casing 811 further includes a boss 8115 located at the center of the first casing 811 as viewed from the −Z direction, and a receiving portion 8116.

The boss 8115 protrudes in the −Z direction from a surface in the −Z direction of the first casing 811, and the insertion opening 8111 described above passes through the boss 8115 along the Z axis. The boss 8115 is a portion for ensuring the strength of the first casing 811 against the shaft portion 5 that rotates in state where the insertion portion 513 is inserted into the insertion opening 8111.

The receiving portion 8116 is a protrusion open in the −Z direction. An insertion portion 8128 of the second casing 812 is inserted into the receiving portion 8116.

### Configuration of Second Casing

The second casing 812 is assembled with the first casing 811 by the screws SC4 described above. The second casing 812 has a circular shape as viewed from the +Z direction. The second casing 812 includes a circumferential wall 8121, a hollow cylindrical portion 8122, the insertion opening 8123, a recess 8124, bosses 8125, screw holes 8126, a locking portion 8127, and the insertion portion 8128. A surface in the −Z direction of the second casing 812 is a connection surface 8129 connected to the first rotary body 82 through the adhesive tape 85.

The circumferential wall 8121 is a portion protruding in the +Z direction from an outer circumferential edge of the second casing 812 as viewed from the +Z direction.

The hollow cylindrical portion 8122 is a hollow cylindrical part protruding in the +Z direction from the center of the second casing 812 as viewed from the +Z direction. The hollow cylindrical portion 8122 has the insertion opening 8123 with a substantially circular shape that passes through the second casing 812 along the Z axis.

The protrusion 514 of the shaft 51 is inserted through the insertion opening 8123, the insertion portion 513 of the shaft 51 being inserted into the insertion opening 8111 of the first casing 811.

The recess 8124 is a portion disposed on an inner side with respect to the circumferential wall 8121 and on an outer side with respect to the hollow cylindrical portion 8122 as viewed from the +Z direction, and recessed in the −Z direction from the circumferential wall 8121. The multiple bosses 8125 and the locking portion 8127 protrude from a bottom of the recess 8124.

The multiple bosses 8125 are provided at substantially equal intervals along a circumferential direction centered on the hollow cylindrical portion 8122 as viewed from the +Z direction. The four bosses 8125 are provided in the exemplary embodiment. Each boss 8125 protrudes in the +Z direction from the bottom of the recess 8124, and the first biasing member 813 is disposed at each boss 8125. Each boss 8125 includes the screw hole 8126 on a surface in the +Z direction, and the screw SC5 inserted through the two-stage hole 8112 is fixed into the screw hole 8126.

The locking portion 8127 having a hook shape is provided at a position in the +X direction and in the −Y direction on the bottom of the recess 8124. The locking portion 8127 locks the other end of the second biasing member 814, one end of which is locked by the locking portion 8114 of the first casing 811.

The insertion portion 8128 is inserted into the receiving portion 8116 of the first casing 811 when the first casing 811 and the second casing 812 are assembled together. One of the first casing 811 and the second casing 812 is thus inhibited from rotating around the rotation axis Rx1 relative to the other of the casings.

### Configuration of First Biasing Members

The first biasing member 813 corresponds to a biasing member of the invention. The first biasing members 813 are arranged in the circumferential direction centered on the rotation axis Rx1 by being attached to the respective bosses 8125. The first biasing members 813 bias the second casing 812, which is in contact with the first rotary body 82, in the −Z direction relative to the first casing 811, thereby pressing the first rotary body 82 toward the second rotary body 83.

In the exemplary embodiment, each first biasing member 813 is provided in a form of a compression coil spring. However, the first biasing member 813 is not limited thereto, and may be provided in a form of an elastic body that elastically deforms to bias the second casing 812 in the −Z direction relative to the first casing 811, or may be provided in a form of another spring member such as a plate spring.

The first biasing members 813 are not necessarily disposed at multiple positions in the circumferential direction centered on the rotation axis Rx1. For example, the first biasing member 813 may be a single coil spring or a single ring-shaped elastic member surrounding the hollow cylindrical portion 8122 as viewed along the rotation axis Rx1.

### Configuration of Second Biasing Member

The second biasing member 814 is locked by the locking portion 8114 of the first casing 811 and the locking portion 8127 of the second casing 812. The second biasing member 814 biases the second casing 812 in a direction for the locking portion 8127 to approach the locking portion 8114. That is, the second biasing member 814 biases the second casing 812 clockwise relative to the first casing 811 as viewed from the +Z direction. The second biasing member 814 as described above inhibits one of the first casing 811 and the second casing 812 from rattling relative to the other of the casings.

In the exemplary embodiment, the second biasing member 814 is provided in a form of a tension coil spring. However, the second biasing member 814 is not limited thereto, and may be provided in a form of an elastic body or another spring member as long as the above-described functions of the second biasing member 814 are achievable.

### Operations of Operator Body

The operations of the operator body 4 will be described below with reference to the cross-sectional views in FIGS. 4 and 5.

As illustrated in FIGS. 4 and 5, when the operation knob 52 exposed outside the housing 3 is rotated by a user around the rotation axis Rx1 along the Z axis, the shaft portion 5 rotates in the same direction. Since the shaft 51 of the shaft portion 5 is inserted through the detector body 62 of the detector 6, the rotation angle of the shaft portion 5 is detected by the detector body 62.

Meanwhile, the first casing 811 of the pressing portion 81, into which the insertion portion 513 of the shaft 51 is inserted, rotates around the rotation axis Rx1 together with the shaft portion 5, thereby rotating the second casing 812 in the same direction. When the second casing 812 rotates, the first rotary body 82 connected to the connection surface 8129 of the second casing 812 through the adhesive tape 85 rotates together with the second casing 812 around the rotation axis Rx1 in the same direction as the second casing 812.

Here, since the shaft portion 5 is connected to the rotary member 71 of the rotary damper 7 through the first rotary body 82 and the second rotary body 83, the load torque of the rotary damper 7, i.e., the rotary torque of the shaft portion 5 increases as the rotation speed of the shaft portion 5 increases.

When the rotary torque of the shaft portion 5 in accordance with the rotation speed of the shaft portion 5 is equal to or less than the friction torque between the first rotary body 82 and the second rotary body 83, the rotation of the shaft portion 5 is transmitted to the rotary damper 7 via the first rotary body 82 and the second rotary body 83.

More specifically, when the shaft portion 5 is rotated at a low speed, the first rotary body 82 rotates the second rotary body 83, which has the surface 83A in frictional engagement with the surface 82B of the first rotary body 82, coaxially in the same direction and at the same speed as the first rotary body 82.

When the second rotary body 83 rotates, the holding member 84 adhered to the second rotary body 83 through the adhesive tape 86 rotates coaxially in the same direction and at the same speed as the second rotary body 83.

The rotary member 71 of the rotary damper 7 is connected to the holding member 84. Therefore, when the holding member 84 rotates, the rotation of the shaft portion 5 is transmitted to the rotary member 71, causing the rotary member 71 to rotate. A braking force acts on the rotation of the rotary member 71 due to viscous resistance of oil in the container 72, and then a braking force of the rotary damper 7 acts on the rotation of the shaft portion 5. Consequently, in a low-speed rotation range where the rotary torque of the shaft portion 5 is equal to or less than the above-described friction torque, the rotation load on the shaft portion 5 increases as the rotation speed of the shaft portion 5 increases.

On the other hand, when the rotary torque of the shaft portion 5 in accordance with the rotation speed of the shaft portion 5 is larger than the above-described friction torque, the first rotary body 82 connected to the shaft portion 5 slips relative to the second rotary body 83 connected to the rotary damper 7. Therefore, the rotation of the shaft portion 5 is less likely to be transmitted to the rotary damper 7 via the first rotary body 82 and the second rotary body 83.

More specifically, when the shaft portion 5 is rotated at a high speed, the surface 82B of the first rotary body 82 slips relative to the surface 83A of the second rotary body 83, so that the first rotary body 82 cannot rotate the second rotary body 83 in the same direction and at the same speed as the first rotary body 82. In other words, the second rotary body 83 cannot follow the rotation of the first rotary body 82 and does not rotate integrally with the first rotary body 82. Accordingly, the rotation of the shaft portion 5 is less likely to be transmitted to the rotary member 71, and the rotary member 71 does not rotate at the same rotation speed as the shaft portion 5, making it difficult to apply the braking force of the rotary damper 7 to the rotation of the shaft portion 5. Consequently, in a high-speed rotation range where the rotary torque of the shaft portion 5 exceeds the above-described friction torque, the rotation load on the shaft portion 5 is substantially constant irrespective of the rotation speed of the shaft portion 5, and the rotation load is reduced compared with a case where the shaft portion 5 is directly connected to the rotary damper 7.

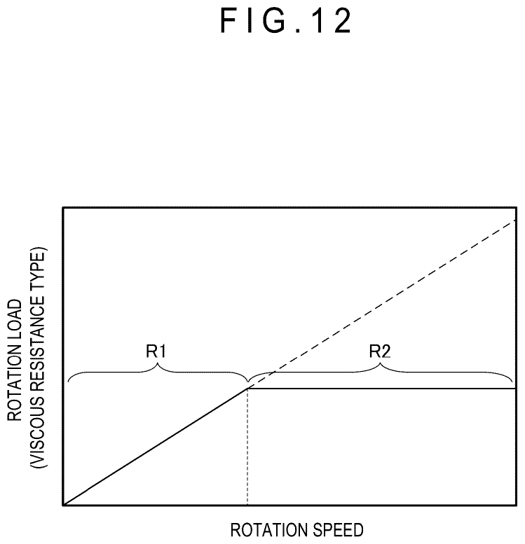

FIG. 12 is a graph illustrating the rotation speed of the shaft portion 5 and the rotation load on the shaft portion 5.

As described above, in a low-speed rotation range R1 of the shaft portion 5, the rotation of the shaft portion 5 is transmitted to the rotary damper 7 via the rotation transmitting mechanism 8. Thus, as illustrated in FIG. 12, the rotation load on the shaft portion 5 increases as the rotation speed of the shaft portion 5 through the rotation operation by a user increases. This allows the shaft portion 5 to be rotated finely, enabling fine adjustment of the rotation angle of the shaft portion 5.

On the other hand, in a high-speed rotation region R2 of the shaft portion 5, since the first rotary body 82 slips relative to the second rotary body 83, the transmission of the rotation of the shaft portion 5 to the rotary damper 7 is inhibited. Therefore, even if the rotation speed of the shaft portion 5 increases through the rotation operation by the user, the rotation load on the shaft portion 5 remains substantially constant. Accordingly, the shaft portion 5 can be rotated at a high speed and with a large rotation angle.

A threshold value of the rotation speed of the shaft portion 5 serving as a boundary between the low-speed rotation range R1 and the high-speed rotation range R2 is set by the adjustment mechanism 9. This threshold value of the rotation speed can be referred to as a first speed of the invention.

### Configuration of Adjustment Mechanism

FIG. 13 is a perspective view illustrating the adjustment mechanism 9 viewed from the +Z direction.

The adjustment mechanism 9 adjusts the friction torque between the first rotary body 82 and the second rotary body 83 by adjusting a pressing force of the pressing portion 81 against the first rotary body 82. The adjustment mechanism 9 thus adjusts the threshold value of the rotation speed of the shaft portion 5 set for switching between an instance where the rotation of the shaft portion 5 is transmitted to the rotary damper 7 via the rotation transmitting mechanism 8 and an instance where the rotation of the shaft portion 5 is less likely to be transmitted to the rotary damper 7. That is, the adjustment mechanism 9 adjusts not only the friction torque between the first rotary body 82 and the second rotary body 83, but also the maximum value of the rotation load on the shaft portion 5 when the first rotary body 82 and the second rotary body 83 rotate integrally due to frictional engagement.

The adjustment mechanism 9 includes a dial 91 and the cam member 92, as illustrated in FIG. 13.

### Configuration of Dial

The dial 91 is rotated by, for example, an adjuster such as a manufacturer of the audio control device 1. A rotation axis Rx2 of the dial 91, which is a rotation axis along the Z axis, is parallel to the rotation axis Rx1 of the shaft portion 5.

The dial 91 includes the shaft 911, an operation portion 912, and a transmitter 913 that are integrally configured.

The shaft 911 is a columnar portion with a central axis along the Z axis. The shaft 911 is supported by the support portion 323 included in the housing 3 in a state inserted through the hole 324 (see FIG. 6) of the support portion 323 along the Z axis.

The operation portion 912 is provided at a +Z-directional end of the shaft 911 and is disposed in the +Z direction relative to the top surface portion 321 (see FIG. 6) included in the holding member 32 of the housing 3. The operation portion 912 has an outer diameter larger than that of the shaft 911. When the operation portion 912 is rotated by the above adjuster, the dial 91 rotates around the rotation axis Rx2.

The transmitter 913 is a pinion gear provided at a −Z-directional end of the shaft 911. That is, the transmitter 913 is a gear having multiple gear teeth arranged in a circumferential direction centered on the rotation axis Rx2. Since the transmitter 913 meshes with the cam member 92, when the dial 91 is rotated, the cam member 92 rotates in an opposite direction to the rotation direction of the dial 91.

### Configuration of Cam Member

The cam member 92 engages with the dial 91. Specifically, the cam member 92 meshes with the transmitter 913 of the dial 91.

The cam member 92 is rotated by a rotational force of the dial 91 to press the first rotary body 82 and the second rotary body 83 toward the pressing portion 81. More specifically, the cam member 92 moves in the ±Z direction the first rotary body 82, the second rotary body 83, the holding member 84, and the rotary damper 7 that are disposed between the pressing portion 81 and the cam member 92, thereby pressing the first rotary body 82 toward the pressing portion 81. The pressing force of the pressing portion 81 against the first rotary body 82 is thus adjusted.

The cam member 92 has a discoidal shape as viewed from the +Z direction and is disposed on the base 31 of the housing 3 to be rotatable around the rotation axis Rx1.

The cam member 92 includes the insertion opening 921, an opening 922, a meshing portion 923, and the end face cam portion 924.

The insertion opening 921 is provided at the center of the cam member 92 as viewed from the +Z direction and passes through the cam member 92 along the Z axis. The boss 314 provided at the base 31 is inserted into the insertion opening 921 from the −Z direction. With this arrangement, the cam member 92 is rotatably supported by the base 31.

The opening 922 is provided in an arc shape on an outer circumferential side of the cam member 92 with respect to the insertion opening 921. The opening 922 is an opening for avoiding the boss 727 provided at the rotary damper 7 and inserted into the hole 316 of the base 31.

The meshing portion 923 is provided at a position facing the −X direction on an outer circumferential surface of the cam member 92. The meshing portion 923 has multiple gear teeth provided along the outer circumferential surface of the cam member 92, and the multiple gear teeth mesh with the transmitter 913 of the dial 91. That is, the cam member 92 meshes with the transmitter 913 of the dial 91 at the meshing portion 923 and rotates around the rotation axis Rx1 in response to the rotation operation of the dial 91.

The end face cam portion 924 is provided on a surface 925 facing in the +Z direction of the cam member 92. That is, the end face cam portion 924 is provided on the surface 925 of the cam member 92 opposing the rotary damper 7. The end face cam portion 924 is provided along the circumferential direction centered on the rotation axis Rx1 so that a protrusion amount from the surface 925 increases in a clockwise direction as viewed from the +Z direction. The end face cam portion 924 is inserted into the groove 728 (see FIG. 9) of the rotary damper 7 from the −Z direction, and moves the rotary damper 7 in the +Z direction in accordance with the rotation of the cam member 92.

More specifically, the end face cam portion 924 includes three cam portions 9241, 9242, and 9243 arranged at equal intervals in the circumferential direction centered on the rotation axis Rx1. Each of the cam portions 9241 to 9243, which has an arc shape along the circumferential direction centered on the rotation axis Rx1, is provided so that a protrusion amount from the surface 925 increases in the clockwise direction as viewed from the +Z direction. Each of the cam portions 9241 to 9243 is inserted into the corresponding one of the regions 7281 to 7283 of the groove 728. Each of the cam portions 9241 to 9243 moves the rotary damper 7 in the ±Z direction in accordance with the rotation of the cam member 92, thereby moving the first rotary body 82, the second rotary body 83, the holding member 84, and the rotary damper 7 in a direction approaching or away from the pressing portion 81.

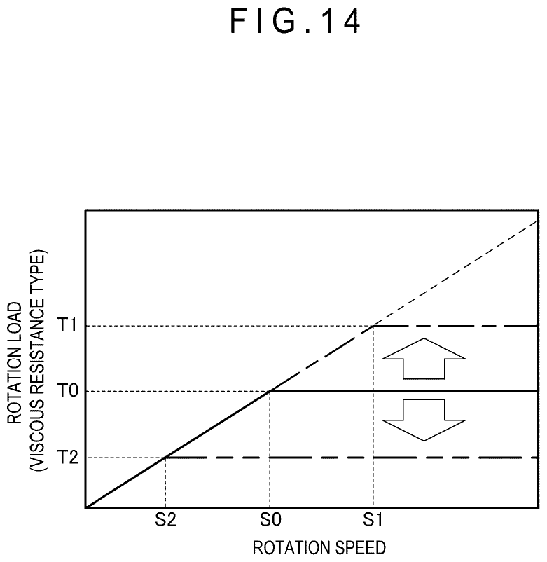

FIG. 14 is a graph illustrating a relationship between the rotation speed of the shaft portion 5 and the rotation load on the shaft portion 5. The graph in FIG. 14 illustrates the state adjusted by the adjustment mechanism 9.

In accordance with the rotation of the dial 91, the cam member 92 rotates in the opposite direction to the dial 91, thereby moving the first rotary body 82, the second rotary body 83, the holding member 84, and the rotary damper 7 in the +Z direction or the −Z direction. Accordingly, the pressing force of the pressing portion 81 against the first rotary body 82 is changed, and the friction torque between the first rotary body 82 and the second rotary body 83 is changed.

For example, when the dial 91 rotates clockwise as viewed from the +Z direction, the cam member 92 rotates counterclockwise. In this case, the rotary damper 7 is moved in the +Z direction by the cam member 92, causing the first biasing members 813 to contract, which increases the pressing force of the pressing portion 81 against the first rotary body 82 to increase the above-mentioned friction torque. This makes it easier for the second rotary body 83 to rotate following the rotation of the first rotary body 82, and as indicated by the dashed line in FIG. 14, the maximum value of the rotation load on the shaft portion 5 increases from a value T0 before the operation of the dial 91 to a value T1. That is, the threshold value of the rotation speed of the shaft portion 5, in a case where the rotation transmitting mechanism 8 transmits the rotation of the shaft portion 5 to the rotary damper 7, increases from a value S0 before the operation of the dial 91 to a value S1.

On the other hand, when the dial 91 is rotated counterclockwise as viewed from the +Z direction, the cam member 92 rotates clockwise. In this case, the rotary damper 7 is moved in the −Z direction by the cam member 92, causing the first biasing members 813 to extend, which decreases the pressing force of the pressing portion 81 against the first rotary body 82 to decrease the above-described friction torque. This makes it difficult for the second rotary body 83 to rotate following the rotation of the first rotary body 82, and as indicated by the double-dashed line in FIG. 14, the maximum value of the rotation load on the shaft portion 5 decreases from the value T0 before the operation of the dial 91 to a value T2. That is, the threshold value of the rotation speed of the shaft portion 5, in a case where the rotation transmitting mechanism 8 transmits the rotation of the shaft portion 5 to the rotary damper 7, decreases from the value S0 before the operation of the dial 91 to a value S2.

As described above, by performing the rotation operation of the dial 91, the threshold value of the rotation speed of the shaft portion 5, in a case where the rotation transmitting mechanism 8 transmits the rotation of the shaft portion 5 to the rotary damper 7, can be adjusted and thus, the maximum value of the rotation load on the shaft portion 5 can be adjusted. Consequently, versatility of the rotary operator 2 can be enhanced and also user-friendliness can be improved.

As illustrated in FIGS. 2 and 3, a lock member RM, which locks the rotation of the dial 91 by meshing with the transmitter 913 of the dial 91, can be attached to the base 31 of the housing 3 by a screw SC6. The lock member RM is capable of restricting the rotation of the dial 91 after adjustment, thereby preventing the above-described threshold value of the rotation speed of the shaft portion 5 and the maximum value of the rotation load on the shaft portion 5 from being unintentionally changed. As a case where the locking member RM is attached, it is envisaged that the manufacturer of the audio control device 1 conducts rotation load adjustment using the adjustment mechanism 9 before shipping the audio control device 1.

On the other hand, when the audio control device 1 is configured so that the rotation operation of the dial 91 can be performed by a user, the locking member RM is not provided at the base 31. In a case where the lock member RM is not provided, the first rotary body 82 and the second rotary body 83 may be separated from each other on the Z axis when the rotary damper 7 is moved in the −Z direction by the cam member 92. In this case, since the rotation load on the shaft portion 5 is minimized irrespective of the rotation speed of the shaft portion 5, an adjustable range of the rotation load on the shaft portion 5 can be expanded, and versatility of the rotary operator 2 can be further enhanced.

### Advantage(s) of First Exemplary Embodiment

The following advantages can be achieved by the audio control device 1 according to the above-described exemplary embodiment.

The audio control device 1 includes the rotary operator 2.

The rotary operator 2 includes the shaft portion 5, the first rotary body 82, the second rotary body 83, the rotary damper 7, and the pressing portion 81.

The shaft portion 5 is rotated around the rotation axis Rx1 by a user.

The first rotary body 82 rotates together with the shaft portion 5.

The second rotary body 83 has the surface 83A that comes into surface contact with the surface 82B of the first rotary body 82. The surface 82B corresponds to the first surface, and the surface 83A corresponds to the second surface.

The rotary damper 7 is connected to the second rotary body 83.

The pressing portion 81 presses the first rotary body 82 against the second rotary body 83.

With this configuration, the first rotary body 82 rotates together with the shaft portion 5. At this time, since the first rotary body 82 is pressed toward the second rotary body 83 by the pressing portion 81, when the shaft portion 5 rotates at a low speed, the second rotary body 83, which has the surface 83A in frictional engagement with the surface 82B, rotates integrally with the first rotary body 82. As the second rotary body 83 is connected to the rotary damper 7, the rotation of the second rotary body 83, i.e., the rotation of the shaft portion 5 is transmitted to the rotary damper 7 and is thereby braked. Therefore, when the shaft portion 5 is rotated at a low speed, it is possible to increase the rotation load on the shaft portion 5.

On the other hand, when the shaft portion 5 rotates at a high speed, the surface 82B slips relative to the surface 83A, whereby the rotation of the first rotary body 82 is less likely to be transmitted to the second rotary body 83 and, consequently, to the rotary damper 7. In this case, even if the rotation speed of the shaft portion 5 further increases, the rotation load on the shaft portion 5 remains substantially constant. That is, when the shaft portion 5 is rotated at a high speed, the rotation load on the shaft portion 5 can be reduced compared with a configuration in which the shaft portion 5 is directly connected to the rotary damper 7.

The rotation load on the shaft portion 5 can thus be changed according to the rotation speed of the shaft portion 5. Accordingly, when the shaft portion 5 is rotated finely, it can be rotated with a high rotation load, and when the shaft portion 5 is rotated at a high speed, it can be rotated with a substantially constant rotation load. Consequently, the rotation operation of the shaft portion 5 can be easily performed, facilitating the operation of the rotary operator 2 depending on application or operating condition thereof.

In the rotary operator 2, when the rotation speed of the shaft portion 5 is less than the above-described threshold value, the first rotary body 82 and the second rotary body 83 rotate integrally. When the rotation speed of the shaft portion 5 is equal to or greater than the threshold value, the surface 82B of the first rotary body 82 slips relative to the surface 83A of the second rotary body 83.

With this configuration, when the rotation speed of the shaft portion 5 is less than the threshold value, substantially the entirety of the rotation of the shaft portion 5 is transmitted to the rotary damper 7, so that the rotation load on the shaft portion 5 can be increased. This allows the shaft portion 5 to be rotated finely, enabling the fine adjustment of the rotation angle of the shaft portion 5.

On the other hand, when the rotation speed of the shaft portion 5 is equal to or greater than the threshold value, the transmission of the rotation of the shaft portion 5 to the rotary damper 7 is inhibited, which can make it less likely to apply the braking force of the rotary damper 7 to the rotation of the shaft portion 5. Accordingly, the rotation load on the shaft portion 5 can be reduced and the high-speed rotation of the shaft portion 5 can be easily performed, compared with a case where the shaft portion 5 is directly connected to the rotary damper 7.

The rotary operator 2 includes the adjustment mechanism 9 for changing the above-described threshold value.

With this configuration, the threshold value of the rotation speed of the shaft portion 5, in a case where the rotation of the shaft portion 5 is transmittable to the rotary damper 7, can be changed depending on, for example, application of the rotary operator 2 and preference of an operator of the rotary operator 2. Consequently, versatility and operability of the rotary operator 2 can be enhanced.

In the rotary operator 2, the adjustment mechanism 9 includes the dial 91 and the cam member 92.

The dial 91 is rotated by the above-mentioned adjuster.

The cam member 92 is rotated by the rotational force of the dial 91. The cam member 92 presses the first rotary body 82 and the second rotary body 83 toward the pressing portion 81.

With this configuration, it is possible that the adjustment mechanism 9 has a relatively simple configuration. In addition, since the above-described threshold value can be changed by only rotating the dial 91, an operation for changing the threshold value can be easily performed.

In the rotary operator 2, the cam member 92 rotates around the rotation axis Rx1 by the rotational force of the dial 91, thereby pressing the first rotary body 82, the second rotary body 83, and the rotary damper 7 toward the pressing portion 81.

With this configuration, since a direction of the pressing force exerted by the pressing portion 81 and a direction of the pressing force exerted by the cam member 92 are opposite to each other, even if the cam member 92 presses the first rotary body 82, the second rotary body 83, and the rotation damper 7 slightly, the pressing force exerted by the pressing portion 81 can be increased. In addition, since the pressing portion 81, the first rotary body 82, the second rotary body 83, the rotary damper 7, and the cam member 92 can be closely arranged, the rotary operator 2 can be compactly configured.

In the rotary operator 2, the surfaces 82B and 83A are orthogonal to the rotation axis Rx1.

The pressing portion 81 presses the first rotary body 82 toward the second rotary body 83 along the rotation axis Rx1.

With this configuration, the surface 82B and the surface 83A can be easily brought into close contact with each other by the pressing force of the pressing portion 81. Consequently, when the shaft portion 5 rotates at a low speed, the rotation of the first rotary body 82 can be easily transmitted to the second rotary body 83.

In the rotary operator 2, the pressing portion 81 includes the multiple first biasing members 813 arranged in the circumferential direction centered on the rotation axis Rx1. The first biasing member 813 corresponds to the biasing member of the invention.

With this configuration, a pressing force can be applied evenly to the first rotary body 82 in the circumferential direction centered on the rotation axis Rx1. Therefore, the first rotary body 82 and the second rotary body 83 can be easily brought into close contact with each other, and the rotation of the shaft portion 5 can be easily transmitted to the second rotary body 83 and, consequently, to the rotary damper 7.

In the rotary operator 2, the first rotary body 82 and the pressing portion 81 are configured integrally.

With this configuration, an increase in number of components of the rotary operator 2 can be inhibited, and the rotary operator 2 can be simply configured.

### Second Exemplary Embodiment

A second exemplary embodiment of the invention will be described below.

An audio control device according to the second exemplary embodiment has the same configuration as the audio control device 1 according to the first exemplary embodiment, but differs in that a rotary operator similar to the rotary operator 2 according to the first exemplary embodiment is adopted for a cross fader. In the following description, components that are identical or substantially identical to those already described are indicated by the same reference codes, and the description thereof is omitted.

### Schematic Configuration of Audio Control Device

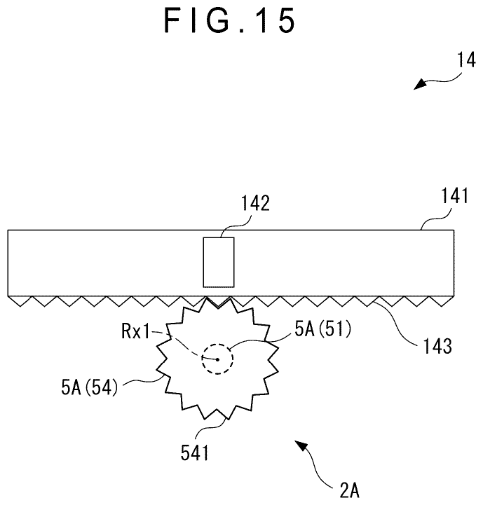

FIG. 15 schematically illustrates a cross fader 14 included in the audio control device according to the second exemplary embodiment.

The audio control device according to the second exemplary embodiment has the same configuration and functions as the audio control device 1 according to the first exemplary embodiment except that it includes the cross fader 14 illustrated in FIG. 15 in place of the cross fader 13.

The cross fader 14, which includes a slider 141 and a rotary operator 2A, has the same functions as the cross fader 14 according to the first exemplary embodiment.

### Configuration of Slider

The slider 141 is provided to be slidable in a right-left direction in the audio control device. The slider 141 includes an operation knob 142 and a rack 143.

The operation knob 142, which is exposed on the upper surface 112 of the audio control device, is gripped by a user. When the operation knob 142 is slid in the right-left direction, the slider 141 slides in the same direction.

The rack 143 is provided on a side surface close to the rotary operator 2A in the slider 141. The rack 143 has multiple gear teeth arranged along a sliding direction of the slider 141. The rack 143 meshes with a pinion 54 of the rotary operator 2A to rotate the pinion 54 and, consequently, the shaft 51 around the rotation axis Rx1.

### Configuration of Rotary Operator

The rotary operator 2A has the same configuration and functions as the rotary operator 2 according to the first exemplary embodiment except that it includes a shaft portion 5A in place of the shaft portion 5. The shaft portion 5A has the same configuration and functions as the shaft portion 5 except that it includes the pinion 54 in place of the operation knob 52. That is, the shaft portion 5A includes the shaft 51 and the pinion 54.

The pinion 54, which is fixed to the +Z-directional end of the shaft 51, rotates integrally with the shaft 51 around the rotation axis Rx1. The pinion 54 has multiple gear teeth 541 provided on an outer circumferential portion of the pinion 54 centered on the rotation axis Rx1.

The pinion 54 meshes with the rack 143 through the multiple gear teeth 541 and rotates together with the shaft 51 around the rotation axis Rx1 in response to sliding of the slider 141.

Therefore, when the slider 141 is slid within a range where the rotation speed of the shaft portion 5A is less than the above-described maximum value, the rotation of the shaft portion 5A is transmitted to the rotary damper 7, making it possible to apply the braking force of the rotary damper 7 to the sliding of the slider 141. Since the load is thus applied to the sliding of the slider 141, fine adjustment of the position of the slider 141 can be easily performed.

On the other hand, when the slider 141 is slid within a range where the rotation speed of the shaft portion 5A is equal to or greater than the maximum value of the rotation speed described above, the rotation of the shaft portion 5A is not transmitted to the rotary damper 7, so that the braking force of the rotary damper 7 is not applied to the sliding of the slider 141. Since the load is not applied to the sliding of the slider 141, the slider 141 can be easily slid at a high speed.

The similar advantages to those of the audio control device 1 of the first exemplary embodiment can be achieved by the audio control device according to the second exemplary embodiment.

As with the cross fader 14, a configuration including the slider 141 and the rotary operator 2A may be adopted for the channel fader 123 and/or may be adopted for the tempo slider 124.

### Modification(s) of Exemplary Embodiments

The invention is not limited to the above exemplary embodiments, and modifications, improvements, and the like are within the scope of the invention, insofar as the object of the invention is achievable.

In each of the above exemplary embodiments, the first rotary body 82 and the pressing portion 81 for pressing the first rotary body 82 toward the second rotary body 83 are adhered together through the adhesive tape 85. However, the arrangement is not limited thereto, and the first rotary body 82 may be at least a part of the pressing portion 81. Specifically, when the pressing portion 81 rotates together with the shaft portion 5, a part of the pressing portion 81 may function as the first rotary body 82, and a surface of the pressing portion 81 opposing the surface 83A of the second rotary body 83 may come into surface contact with the surface 83A. In this case, the surface of the pressing portion 81 opposing the surface 83A corresponds to the first surface.

On the other hand, the pressing portion 81 needs not rotate integrally with the shaft portion 5 as long as the pressing portion 81 is capable of pressing the first rotary body 82, as the first rotary body, toward the second rotary body 83. In this case, the pressing portion may be configured including, for example, a roller having a rotation axis orthogonal to the rotation axis Rx1 while pressing the first rotary body 82.

In each of the above exemplary embodiments, the rotation transmitting mechanism 8 includes the first rotary body 82 and the second rotary body 83, and the surface 82B as the first surface that is orthogonal to the rotation axis Rx1 in the first rotary body 82 is frictionally engaged with the surface 83A as the second surface that is orthogonal to the rotation axis Rx1 and opposes the surface 82B in the second rotary body 83. However, the friction engagement is not limited thereto, and an outer circumferential surface of the first rotary body 82 may be frictionally engaged with an outer circumferential surface of the second rotary body 83. In this case, the pressing portion 81 only needs to apply, to one of the first rotary body 82 and the second rotary body 83, a pressing force toward the other of the rotary bodies.

In each of the above exemplary embodiments, the pressing portion 81 includes the multiple first biasing members 813 that are arranged at equal intervals along the circumferential direction centered on the rotation axis Rx1 and presses the second casing 812 against the first rotary body 82 using the multiple first biasing members 813. However, the configuration is not limited thereto, and in place of the multiple first biasing members 813, a ring-shaped elastic body extending along the circumferential direction centered on the rotation axis Rx1 may be adopted. Alternatively, the number of the first biasing members 813 can be changed as appropriate.

In each of the above exemplary embodiments, the rotary operator 2 includes the adjustment mechanism 9 for changing the maximum value of the rotation speed described above as the first speed. However, the configuration is not limited thereto and the adjustment mechanism 9 may be omitted.

The adjustment mechanism 9 includes the dial 91 and the cam member 92 in each of the above exemplary embodiments. However, the configuration is not limited to the above configuration as long as the pressing force by the pressing portion 81 can be adjusted.

The cam member 92 moves the first rotary body 82, the second rotary body 83, and the rotary damper 7 in a direction approaching or away from the dial 91 in each of the above exemplary embodiments. However, the configuration is not limited thereto, and the cam member 92 may move the pressing portion 81 in a direction approaching or away from the first rotary body 82.

In each of the above exemplary embodiments, the rotary operator 2 or 2A is adopted in the audio control device 1. However, the rotary operator of the invention may be adopted not only in the audio control device but also in other electronic devices.

### DISCLOSURE OF THE INVENTION

The disclosure of the invention is appended below.
[1] A rotary operator including:
a shaft portion rotatable around a rotation axis;
a first rotary body rotatable together with the shaft portion;
a second rotary body having a second surface, the second surface being configured to come into surface contact with a first surface of the first rotary body;
a rotary damper connected to the second rotary body; and
a pressing portion configured to press the first rotary body against the second rotary body.

With this configuration, the first rotary body rotates together with the shaft portion. At this time, since the first rotary body is pressed toward the second rotary body by the pressing portion, when the shaft portion rotates at a low speed, the second rotary body, which has the second surface in frictional engagement with the first surface, rotates integrally with the first rotary body. As the second rotary body is connected to the rotary damper, the rotation of the second rotary body, i.e., the rotation of the shaft portion is transmitted to the rotary damper and is thereby braked. Therefore, when the shaft portion is rotated at a low speed, it is possible to increase the rotation load on the shaft portion.

On the other hand, when the shaft portion rotates at a high speed, the first surface slips relative to the second surface, whereby the rotation of the first rotary body is less likely to be transmitted to the second rotary body and, consequently, to the rotary damper. In this case, even if the rotation speed of the shaft portion further increases, the rotation load on the shaft portion remains substantially constant. That is, when the shaft portion is rotated at a high speed, the rotation load on the shaft portion can be reduced compared with a configuration in which the shaft portion is directly connected to the rotary damper.

The rotation load on the shaft portion can thus be changed according to the rotation speed of the shaft portion. Accordingly, when the shaft portion is rotated finely, it can be rotated with a high rotation load, and when the shaft portion is rotated at a high speed, it can be rotated with a substantially constant rotation load. Consequently, the rotation operation of the shaft portion can be easily performed, facilitating the operation of the rotary operator depending on application or operating condition thereof.
[2] The rotary operator according to [1], in which
when a rotation speed of the shaft portion is less than a threshold value, the first rotary body and the second rotary body are configured to rotate integrally, and
when the rotation speed of the shaft portion is equal to or greater than the threshold value, the first surface is configured to slip relative to the second surface.

With this configuration, in the first rotary body, when the rotation speed of the shaft portion is less than the above-described threshold value substantially the entirety of the rotation of the shaft portion is transmitted to the rotary damper, so that the rotation load on the shaft portion can be increased. This allows the shaft portion to be rotated finely, enabling the fine adjustment of the rotation angle of the shaft portion.

On the other hand, in the first rotary body, when the rotation speed of the shaft portion is equal to or greater than the threshold value, the transmission of the rotation of the shaft portion to the rotary damper is inhibited, which can make it less likely to apply the braking force of the rotary damper to the rotation of the shaft portion. Accordingly, the rotation load on the shaft portion can be reduced and the high-speed rotation of the shaft portion can be easily performed, compared with a case where the shaft portion is directly connected to the rotary damper.
[3] The rotary operator according to [2], further including:
an adjustment mechanism configured to change the threshold value.

With this configuration, the above-described threshold value can be changed depending on, for example, application of the rotary operator and preference of an operator of the rotary operator. Consequently, versatility and operability of the rotary operator can be enhanced.
[4] The rotary operator according to [3], in which
the adjustment mechanism includes:
   a dial configured to be rotated; and
   a cam member configured to be rotated by a rotational force of the dial and to press the first rotary body and the second rotary body toward the pressing portion.

With this configuration, it is possible that the adjustment mechanism has a relatively simple configuration. In addition, since the above-described threshold value can be changed by only rotating the dial, an operation for changing the threshold value can be easily performed.
[5] The rotary operator according to [4], in which
the cam member is configured to rotate around the rotation axis by the rotational force of the dial and to press the first rotary body, the second rotary body, and the rotary damper toward the pressing portion.

With this configuration, since a direction of the pressing force exerted by the pressing portion and a direction of the pressing force exerted by the cam member are opposite to each other, even if the cam member presses the first rotary body, the second rotary body, and the rotation damper slightly, the pressing force exerted by the pressing portion can be increased. In addition, since the pressing portion, the first rotary body, the second rotary body, the rotary damper, and the cam member can be closely arranged, the rotary operator can be compactly configured.
[6] The rotary operator according to any one of [1] to [5], in which
the first surface and the second surface are orthogonal to the rotation axis, and
the pressing portion is configured to press the first rotary body toward the second rotary body along the rotation axis.

With this configuration, the first surface and the second surface can be easily brought into close contact with each other by the pressing force of the pressing portion. Consequently, when the shaft portion rotates at a low speed, the rotation of the first rotary body can be easily transmitted to the second rotary body.
[7] The rotary operator according to any one of [1] to [6], in which
the pressing portion includes a plurality of biasing members arranged in a circumferential direction centered on the rotation axis.

With this configuration, a pressing force can be applied evenly to the first rotary body in the circumferential direction centered on the rotation axis. Therefore, the first rotary body and the second rotary body can be easily brought into close contact with each other, and the rotation of the shaft portion can be easily transmitted to the second rotary body and, consequently, to the rotary damper.
[8] The rotary operator according to any one of [1] to [7], in which
the first rotary body and the pressing portion are configured integrally.

With this configuration, an increase in number of components of the rotary operator can be inhibited. Thus, the rotary operator can be simply configured.
[9] An Audio Control Device Including the Rotary Operator According to Any One of [1] to [8].

With this configuration, the similar advantages to those of the above-described rotary operator can be achieved.

### EXPLANATION OF CODES

1 . . . audio control device, 2, 2A . . . rotary operator, 3 . . . housing, 4 . . . operator body, 5 . . . shaft portion, 51 . . . shaft, 52 . . . operation knob, 6 . . . detector, 7 . . . rotary damper, 8 . . . rotation transmitting mechanism, 81 . . . pressing portion, 811 . . . first casing, 812 . . . second casing, 813 . . . first biasing member (biasing member), 814 . . . second biasing member, 82 . . . first rotary body, 82B . . . surface (first surface), 83 . . . second rotary body, 83A . . . surface (second surface), 84 . . . holding member, 9 . . . adjustment mechanism, 91 . . . dial, 92 . . . cam member, Rx1 . . . rotation axis.

1.-9 (canceled)

10. A rotary operator comprising:
a shaft portion rotatable around a rotation axis;
a first rotary body rotatable together with the shaft portion;
a second rotary body having a second surface, the second surface being configured to come into surface contact with a first surface of the first rotary body;
a rotary damper connected to the second rotary body; and
a pressing portion configured to press the first rotary body against the second rotary body.

11. The rotary operator according to claim 10, wherein
when a rotation speed of the shaft portion is less than a threshold value, the first rotary body and the second rotary body are configured to rotate integrally, and
when the rotation speed of the shaft portion is equal to or greater than the threshold value, the first surface is configured to slip relative to the second surface.

12. The rotary operator according to claim 11, further comprising:
an adjustment mechanism configured to change the threshold value.

13. The rotary operator according to claim 12, wherein
the adjustment mechanism includes:
a dial configured to be rotated; and
a cam member configured to be rotated by a rotational force of the dial and to press the first rotary body and the second rotary body toward the pressing portion.

14. The rotary operator according to claim 13, wherein
the cam member is configured to rotate around the rotation axis by the rotational force of the dial and to press the first rotary body, the second rotary body, and the rotary damper toward the pressing portion.

15. The rotary operator according to claim 10, wherein
the first surface and the second surface are orthogonal to the rotation axis, and
the pressing portion is configured to press the first rotary body toward the second rotary body along the rotation axis.

16. The rotary operator according to claim 10, wherein
the pressing portion includes a plurality of biasing members arranged in a circumferential direction centered on the rotation axis.

17. The rotary operator according to claim 10, wherein
the first rotary body and the pressing portion are configured integrally.

18. An audio control device comprising the rotary operator according to claim 10.
